(19) United States
(12) Patent Application Publication
(10) Pub. No.: US 2026/0128220 A1
(43) Pub. Date: May 7, 2026

(54) MULTILAYER CERAMIC CAPACITOR

(71) Applicant: Murata Manufacturing Co., Ltd., Nagaokakyo-shi (JP)

(72) Inventor: Ryota KARAYA, Nagaokakyo-shi (JP)

(21) Appl. No.: 19/436,363

(22) Filed: Dec. 30, 2025

Related U.S. Application Data
(63) Continuation of application No. PCT/JP2024/014058, filed on Apr. 5, 2024.

(30) Foreign Application Priority Data
Jun. 30, 2023 (JP) 2023-108197

(51) Int. Cl. H01G 4/008; H01G 4/12; H01G 4/232; H01G 4/248; H01G 4/30

(52) U.S. Cl. CPC H01G 4/008; H01G 4/1272; H01G 4/2325; H01G 4/248; H01G 4/30

(57) ABSTRACT

A multilayer ceramic capacitor includes a laminate including dielectric layers and first and second internal electrode layers, and first and second external electrodes respectively on first and second end surfaces. Materials of the first and second internal electrode layers are different from one another. The first internal electrode layers and the dielectric layers are Schottky-joined. The second internal electrode layers and the dielectric layers are Schottky-joined or ohmic-joined. Where no voltage is applied between the first external electrode and the second external electrode, a difference between a work function of the first internal electrode layers and a work function of the dielectric layers is greater than a difference between a work function of the second internal electrode layers and the work function of the dielectric layers.

### CROSS REFERENCE TO RELATED APPLICATIONS

This application claims the benefit of priority to Japanese Patent Application No. 2023-108197 filed on Jun. 30, 2023 and is a Continuation Application of PCT Application No. PCT/JP2024/014058 filed on Apr. 5, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors that are each able to maintain capacitance even when a DC voltage is applied have been known. Japanese Unexamined Patent Application, Publication No. 2014-189464 describes using a magnetic composition represented by (Bi₁₋ₓSrₓ)(Fe_{1-y}Ti_{y})O₃, where 0.2≤x≤0.7 and 0.2≤y≤0.7, and having a sintered body average particle size of 1.0 μm or less, for a material of dielectric layers included in a multilayer ceramic capacitor.

However, in conventional multilayer ceramic capacitors, there is room for improvement in that the capacitance that can be maintained is not sufficient in some cases.

### SUMMARY OF THE INVENTION

Example embodiments of the present invention provide multilayer ceramic capacitors that are each able to maintain high capacitance even when a DC voltage is applied.

An example embodiment of the present invention provides a multilayer ceramic capacitor which includes a multilayer body including a plurality of dielectric layers, a plurality of first internal electrode layers, and a plurality of second internal electrode layers that are laminated, the multilayer body further including a first main surface and a second main surface opposed to each other in a lamination direction, a first end surface and a second end surface opposed to each other in a length direction orthogonal or substantially orthogonal to the lamination direction, and a first lateral surface and a second lateral surface opposed to each other in a width direction orthogonal or substantially orthogonal to the lamination direction and the length direction, a first external electrode on the first end surface, and a second external electrode on the second end surface, in which a material of the plurality of first internal electrode layers and a material of the plurality of second internal electrode layers are different from each other, each one of the plurality of first internal electrode layers and a corresponding one of the plurality of dielectric layers define a Schottky junction, each one of the plurality of second internal electrode layers and a corresponding one of the plurality of dielectric layers define a Schottky junction or an ohmic contact, and in a state where no voltage is applied between the first external electrode and the second external electrode, a difference between a work function of each of the plurality of first internal electrode layers and a work function of each of the plurality of dielectric layers is greater than a difference between a work function of each of the plurality of second internal electrode layers and the work function of each of the plurality of dielectric layers.

According to example embodiments of the present invention, multilayer ceramic capacitors that are each able to maintain high capacitance even when a DC voltage is applied are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to an example embodiment of the present invention.

FIG. 2 is a cross-sectional view taken along the line I-I in FIG. 1.

FIG. 3 is a cross-sectional view taken along the line II-II in FIG. 1.

FIG. 4 is an explanatory diagram showing an enlarged portion of FIG. 2.

FIG. 5 is a graph showing the relationship between DC voltage and capacitance.

### DETAILED DESCRIPTION OF THE EXAMPLE EMBODIMENTS

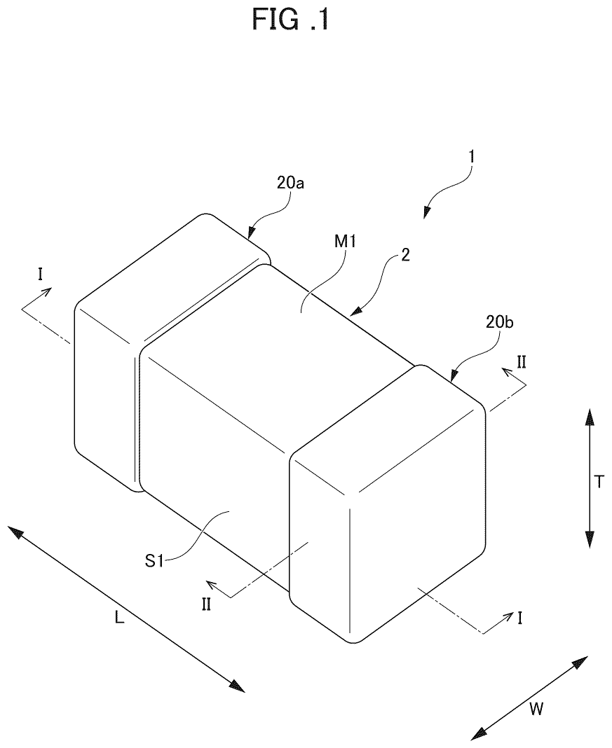

Example embodiments of the present invention will be described in detail below with reference to the drawings. FIG. 1 is a perspective view of a multilayer ceramic capacitor 1 according to an example embodiment of the present invention. The multilayer ceramic capacitor 1 includes a multilayer body 2 and external electrodes. The external electrodes include a first external electrode 20a and a second external electrode 20b.

The multilayer body 2 includes a plurality of laminated dielectric layers and a plurality of internal electrode layers. The multilayer body 2 has a rectangular or substantially rectangular parallelepiped shape. In the multilayer body 2, the direction in which the dielectric layers and the internal electrode layers are laminated is defined as a lamination direction T. One direction orthogonal or substantially orthogonal to the lamination direction T is defined as a width direction W. The direction orthogonal or substantially orthogonal to the lamination direction T and the width direction W is defined as a length direction L.

In the multilayer body 2, one of the two outer surfaces opposed to each other in the lamination direction T is defined as a first main surface M1. The remaining one outer surface is defined as a second main surface M2. In the multilayer body 2, one of the two outer surfaces opposed to each other in the width direction W is defined as a first lateral surface S1. The remaining one outer surface is defined as a second lateral surface S2. In the multilayer body 2, one of the two outer surfaces opposed to each other in the length direction L is defined as a first end surface E1. The remaining one outer surface is defined as a second end surface E2. The mounting surface of the multilayer ceramic capacitor 1 is defined as the second main surface M2. The mounting surface refers to a surface that faces a wiring board when the multilayer ceramic capacitor 1 is mounted on the wiring board or the like.

Regarding the cross-section of the multilayer ceramic capacitor 1, the cross-section along the line I-I in FIG. 1 is referred to as the LT cross-section. The cross-section along the line II-II in FIG. 1 is referred to as the WT cross-section. Regarding the cross-section of the multilayer body 2, the cross-section along the line III-III in FIG. 1 is referred to as the LW cross-section.

It is preferable that the corner portions and the ridge portions of the multilayer body 2 are rounded. The corner portions are portions where three outer surfaces of the multilayer body 2 intersect. The ridge portions are portions where two outer surfaces of the multilayer body 2 intersect. Irregularities or the like may be provided on part or the entirety of the main surfaces, lateral surfaces, and end surfaces.

The total number of dielectric layers laminated in the multilayer body 2 is, for example, preferably fifteen or more and 2000 or less. The main material of the dielectric layer is a ceramic material. Examples of the ceramic material include dielectric ceramics including BaTiO₃ (barium titanate), CaTiO₃, SrTiO₃, CaZrO₃, or the like as a main component. The dielectric ceramic may include secondary components in addition to the main component. Examples of the secondary components include Mn compounds, Fe compounds, Cr compounds, Co compounds, or Ni compounds.

The material of the dielectric layers may include rare earth elements. Examples of the rare earth elements include Dy, Ho, or the like.

In addition, each of the dielectric layers may include a layer made of a semiconductor material other than barium titanate, in addition to the layer made of barium titanate or the like. Examples of semiconductor materials other than barium titanate include MoS₂, MoOₓ, WSe₂, CdTe, or the like. The layer made of a semiconductor material other than barium titanate will be described later.

The thickness of each dielectric layer is, for example, preferably about 0.5 μm or more and about 10 μm or less.

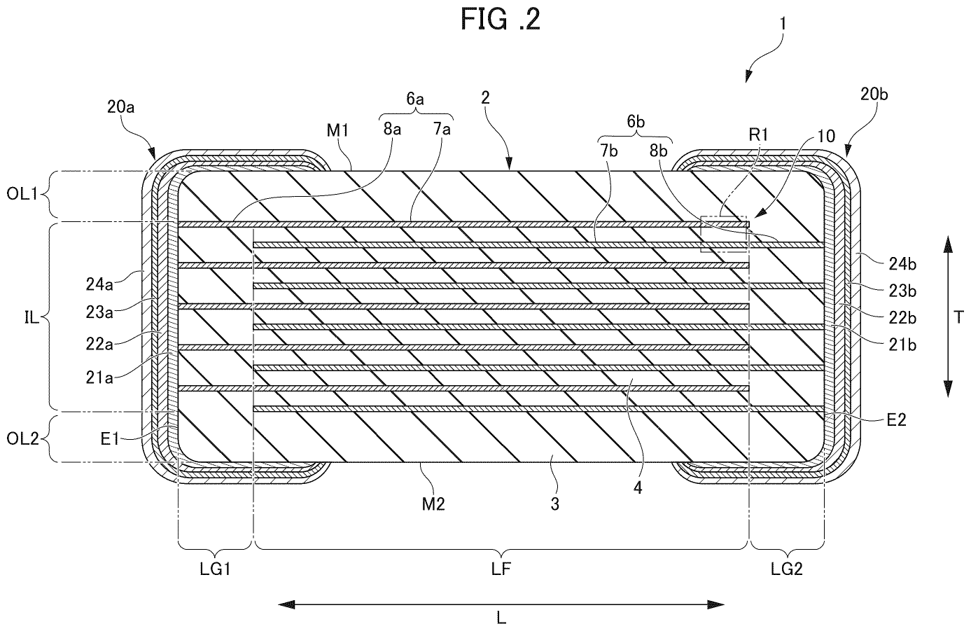

The division of the multilayer body 2 in the lamination direction T will be described based on FIG. 2. FIG. 2 is a cross-sectional view along the line I-I in FIG. 1. The multilayer body 2 is divided into a first main surface-side outer layer portion OL1, an inner layer portion IL, and a second main surface-side outer layer portion OL2 in the lamination direction T. The first main surface-side outer layer portion OL1, the inner layer portion IL, and the second main surface-side outer layer portion OL2 are arranged in this order from the first main surface M1 toward the second main surface M2 in the lamination direction T.

The first main surface-side outer layer portion OL1 is a portion between an internal electrode layer closest to the first main surface M1 and the first main surface M1. The inner layer portion IL is a portion where internal electrode layers are opposed to each other. The second main surface-side outer layer portion OL2 is a portion between an internal electrode layer closest to the second main surface M2 and the second main surface M2.

The first main surface-side outer layer portion OL1 includes an aggregate of a plurality of dielectric layers located between the first main surface M1 and the internal electrode layer closest to the first main surface M1.

The second main surface-side outer layer portion OL2 includes an aggregate of a plurality of dielectric layers located between the second main surface M2 and the internal electrode layer closest to the second main surface M2.

The inner layer portion IL is a portion sandwiched between the first main surface-side outer layer portion OL1 and the second main surface-side outer layer portion OL2. The inner layer portion IL includes a plurality of internal electrode layers and a plurality of laminated dielectric layers which are laminated.

Among the dielectric layers, the dielectric layers provided in the first main surface-side outer layer portion OL1 and the second main surface-side outer layer portion OL2 are referred to as outer dielectric layers 3. Among the dielectric layers, the dielectric layers provided in the inner layer portion IL are referred to as inner dielectric layers 4.

The following terms are used in the description of length and position. The length in the length direction L is referred to as the length direction dimension. The length in the width direction W is referred to as the width direction dimension. The length in the lamination direction T is referred to as the lamination direction dimension.

A position that is about half the length direction dimension of the multilayer body 2 is referred to as the middle position in the length direction. A position that is about half the width direction dimension of the multilayer body 2 is referred to as the middle position in the width direction of the multilayer body 2. A position that is about half the lamination direction dimension of the multilayer body 2 is referred to as the middle position in the lamination direction.

The size of the multilayer body 2 is not particularly limited. The length direction dimension of the multilayer body is, for example, preferably about 0.2 mm or more and about 10 mm or less. The width direction dimension of the multilayer body 2 is, for example, preferably about 0.1 mm or more and about 5 mm or less. The lamination direction dimension of the multilayer body 2 is, for example, preferably about 0.1 mm or more and about 5 mm or less.

The division of the multilayer body 2 in the length direction L will be described. The multilayer body 2 is divided in the length direction L into a first end surface-side outer layer portion LG1, a length direction counter portion LF, and a second end surface-side outer layer portion LG2. The first end surface-side outer layer portion LG1, the length direction counter portion LF, and the second end surface-side outer layer portion LG2 are provided in this order from the first end surface E1 toward the second end surface E2 in the length direction L.

The first end surface-side outer layer portion LG1 is a portion between the length direction counter portion LF and the first end surface E1. The second end surface-side outer layer portion LG2 is a portion between the length direction counter portion LF and the second end surface E2. The length direction counter portion LF is a portion where the first internal electrode layers 6a and the second internal electrode layers 6b are opposed to each other in the lamination direction T.

The length direction counter portion LF corresponds to the counter electrode portion of the internal electrode layers. The first end surface-side outer layer portion LG1 and the second end surface-side outer layer portion LG2 are portions corresponding to the extension electrode portions of the internal electrode layers. The first end surface-side outer layer portion LG1 and the second end surface-side outer layer portion LG2 are referred to as L gaps.

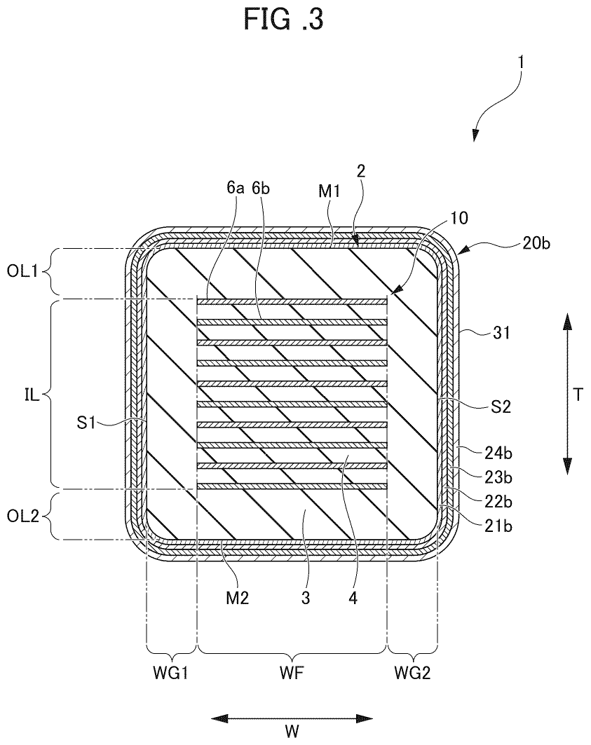

The division of the multilayer body 2 in the width direction W will be described with reference to FIG. 3. FIG. 3 is a cross-sectional view taken along the line II-II in FIG. 1. The multilayer body 2 is divided in the width direction W into a first lateral surface-side outer layer portion WG1, a width direction counter portion WF, and a second lateral surface-side outer layer portion WG2. The first lateral surface-side outer layer portion WG1, the width direction counter portion WF, and the second lateral surface-side outer layer portion WG2 are provided in this order from the first lateral surface S1 toward the second lateral surface S2 in the width direction W.

The width direction counter portion WF is a portion where the internal electrode layers are opposed to each other in the lamination direction T. The first lateral surface-side outer layer portion WG1 is a portion between the width direction counter portion WF and the first lateral surface S1. The second lateral surface-side outer layer portion WG2 is a portion between the width direction counter portion WF and the second lateral surface S2. The first lateral surface-side outer layer portion WG1 and the second lateral surface-side outer layer portion WG2 are referred to as W gaps.

The first lateral surface-side outer layer portion WG1 and the second lateral surface-side outer layer portion WG2 do not include any internal electrode layers in the lamination direction T. The first lateral surface-side outer layer portion WG1 includes a plurality of dielectric layers located between the first lateral surface S1 and the outermost surface of the width direction counter portion WF adjacent to the first lateral surface S1.

The second lateral surface-side outer layer portion WG2 is located adjacent to the second lateral surface S2. The second lateral surface-side outer layer portion WG2 includes a plurality of dielectric layers located between the second lateral surface S2 and the outermost surface of the width direction counter portion WF adjacent to the second lateral surface S2.

The internal electrode layers include a plurality of first internal electrode layers 6a and a plurality of second internal electrode layers 6b. The first internal electrode layers 6a refer to internal electrode layers each exposed at the first end surface E1. The second internal electrode layers 6b refer to internal electrode layers each exposed at the second end surface E2.

Each of the first internal electrode layers 6a is divided into a first counter electrode portion 7a and a first extension electrode portion 8a. The first counter electrode portion 7a is a portion opposed to the second internal electrode layer 6b. The first extension electrode portion 8a is a portion extending from the first counter electrode portion 7a to the first end surface E1.

Each of the second internal electrode layers 6b is divided into a second counter electrode portion 7b and a second extension electrode portion 8b. The second counter electrode portion 7b is a portion opposed to the first internal electrode layer 6a. The second extension electrode portion 8b is a portion extending from the second counter electrode portion 7b to the second end surface E2.

The material of the internal electrode layers can be, for example, a metal such as Ni, Cu, Ag, Pd, or Au. Furthermore, the material of the internal electrode layers can be, for example, an alloy including at least one of the above-described metals, such as an Ag-Pd alloy.

In addition, the internal electrode layers may include, for example, Ni coated with Sn. The Ni coated with Sn will be described later.

In the multilayer ceramic capacitor 1, capacitance is generated by the first counter electrode portion 7a and the second counter electrode portion 7b opposing each other with a corresponding one of the inner dielectric layers 4 interposed therebetween. This enables the multilayer ceramic capacitor 1 to provide capacitor characteristics.

The thickness of the first internal electrode layer 6a and the thickness of the second internal electrode layer 6b are, for example, preferably about 0.2 μm or more and about 2.0 μm or less. The total number obtained by adding the number of the first internal electrode layers 6a and the number of the second internal electrode layers 6b is, for example, preferably 15 or more and 2000 or less.

The external electrodes will be described. The external electrodes include a first external electrode 20a and a second external electrode 20b, as shown in FIGS. 1, 2, etc. The first external electrode 20a is connected to the first internal electrode layers 6a. The first external electrode 20a extends from the first end surface E1 to a portion of the first main surface M1 and a portion of the second main surface M2, and to a portion of the first lateral surface S1 and a portion of the second lateral surface S2.

The second external electrode 20b is connected to the second internal electrode layers 6b. The second external electrode 20b extends from the second end surface E2 to a portion of the first main surface M1 and a portion of the second main surface M2, and to a portion of the first lateral surface S1 and a portion of the second lateral surface S2.

The external electrode preferably includes a base electrode layer and a plated layer. The base electrode layer can include at least one layer of, for example, a fired layer, an electrically conductive resin layer, a thin film layer, and the like. Further, the electrically conductive resin layer can be provided separately from the base electrode layer.

A configuration including a fired layer defining and functioning as the base electrode layer and an electrically conductive resin layer separately from the base electrode layer will be described as an example. In this configuration, the first external electrode 20a includes a first base electrode layer 21a, a first electrically conductive resin layer 22a, a first lower plated layer 23a, and a first upper plated layer 24a. The second external electrode 20b includes a second base electrode layer 21b, a second electrically conductive resin layer 22b, a second lower plated layer 23b, and a second upper plated layer 24b.

The base electrode layer includes a first base electrode layer 21a and a second base electrode layer 21b. The first base electrode layer 21a is provided on the first end surface E1, a portion of the first main surface M1 and a portion of the second main surface M2, and a portion of the first lateral surface S1 and a portion of the second lateral surface S2. The second base electrode layer 21b is provided on the second end surface E2, a portion of the first main surface M1 and a portion of the second main surface M2, and a portion of the first lateral surface S1 and a portion of the second lateral surface S2.

The base electrode layer includes an electrically conductive metal and a glass component. The electrically conductive metal includes, for example, at least one of Cu, Ni, Ag, Pd, Ag-Pd alloy, Au, or the like. The glass component includes, for example, at least one of B, Si, Ba, Mg, Al, Li, or the like.

The base electrode layer is formed as follows. An electrically conductive metal and a glass component are blended to obtain an electrically conductive paste. The electrically conductive paste is applied to the multilayer body. The applied electrically conductive paste is fired.

The firing of the electrically conductive paste can be performed simultaneously with the firing of the internal electrode layers and the firing of the dielectric layers. Alternatively, the firing of the electrically conductive paste can be performed after the firing of the internal electrode layers and the firing of the dielectric layers.

When the firing of the electrically conductive paste is performed simultaneously with the firing of the internal electrode layers and the firing of the dielectric layers, it is preferable to add a dielectric material to the electrically conductive paste. By adding the dielectric material to the electrically conductive paste, it is possible to improve the adhesion between the base electrode layer and the internal electrode layers.

The thickness of the base electrode layer located on the first end surface E1 or the second end surface E2 at the middle position in the lamination direction is, for example, preferably about 10 μm or more and about 150 μm or less.

When the base electrode layer is a thin film layer, the thin film layer can be formed using a thin film forming method. The thin film forming method includes a sputtering method, a vapor deposition method, and the like. The thin film layer is formed as a layer on which metal particles are deposited. The thickness of the formed thin film layer is, for example, about 1 μm or less.

An electrically conductive resin layer is provided on the base electrode layer. The electrically conductive resin layer includes a first electrically conductive resin layer 22a and a second electrically conductive resin layer 22b.

The first electrically conductive resin layer 22a is provided on the first base electrode layer 21a. The first electrically conductive resin layer 22a covers the first base electrode layer 21a. The end portion of the first electrically conductive resin layer 22a is preferably in contact with the multilayer body 2.

The second electrically conductive resin layer 22b is provided on the second base electrode layer 21b. The second electrically conductive resin layer 22b covers the second base electrode layer 21b. The end portion of the second electrically conductive resin layer 22b is preferably in contact with the multilayer body 2.

The electrically conductive resin layer includes a resin component and a metal component. The resin component includes a thermosetting resin, for example. The electrically conductive resin layer is more flexible than the base electrode layer. The reasons are as follows. The electrically conductive resin layer includes a resin component. The base electrode layer does not include a resin component. The base electrode layer is a fired product including, for example, a plating film, a metal component, a glass component, and the like. For these reasons, the electrically conductive resin layer is more flexible than the base electrode layer.

The electrically conductive resin layer defines and functions as a buffer layer. Cracks are less likely to occur in the multilayer ceramic capacitor 1 including the electrically conductive resin layer. This is because, when a bending stress is applied to the substrate on which the multilayer ceramic capacitor 1 is mounted and a physical impact is applied to the multilayer ceramic capacitor 1 due to this stress, the electrically conductive resin layer mitigates the impact. Also, when a shock due to thermal cycling is applied to the multilayer ceramic capacitor 1, the electrically conductive resin layer mitigates the shock.

The electrically conductive resin layer includes a thermosetting resin, for example. The thermosetting resin is selected from, for example, epoxy resin, phenol resin, urethane resin, silicone resin, polyimide resin, or the like. Among these resins, epoxy resin is one of the preferable resins. This is because epoxy resin is excellent in heat resistance, moisture resistance, adhesion, and the like.

The electrically conductive resin layer includes, for example, Ag, Cu, Ni, Sn, Bi, or an alloy including at least one of the metal components. The preferred shape of the metal component is a filler shape. When the metal component is metal powder, the surface of the metal powder may be coated with, for example, Sn, Ni, or Cu.

The metal component preferably includes Ag, for example. Ag may be Ag alone. Ag may be an alloy including Ag. Also, Ag may be included as a coating material for metal powder.

When Ag is used as a coating material for metal powder, there are the following advantages. The specific resistance of Ag is the lowest among metals. Therefore, it is possible to reduce the electrical resistance of the electrically conductive resin layer. Also, Ag is not easily oxidized. Therefore, it is possible to increase the resistance of the electrically conductive resin layer.

The filler-shaped metal component is referred to as a metal filler. The preferred shape of the metal filler includes a spherical shape or a flat shape, for example. The metal filler may be a mixture of spherical metal fillers and flat-shaped metal fillers.

The average particle size of the metal fillers is not particularly limited. The average particle size of the metal fillers can be, for example, about 0.3 μm or more and about 10 μm or less. The average particle size of the metal fillers can be determined by calculation based on the laser diffraction particle size measurement method (based on IOS 13320). This method for determining the average particle size can be used regardless of the shape of the fillers.

The metal fillers make the electrically conductive resin layer capable of conducting electricity. This is because contact between the metal fillers provides an electrical conduction path inside the electrically conductive resin layer.

The electrically conductive resin layer preferably includes a curing agent in addition to the thermosetting resin. When epoxy resin is used as the thermosetting resin, the curing agent is one of, for example, phenol-based, amine-based, acid anhydride-based, imidazole-based, active ester-based, of amidoimide-based compounds.

It is preferable that the amount of metal included in the electrically conductive resin layer is, for example, about 35 vmol % or more and about 75 vmol % or less with respect to the total volume of the electrically conductive resin layer.

It is preferable that the amount of resin included in the electrically conductive resin layer is, for example, about 25 vmol % or more and about 65 vmol % or less with respect to the total volume of the electrically conductive resin layer.

The thickness of the electrically conductive resin layer located on the first end surface E1 or the second end surface E2 at the middle position in the lamination direction is, for example, preferably about 10 μm or more and about 200 μm or less.

When providing electrically conductive resin layers on the first main surface M1 and the second main surface M2, as well as the first lateral surface S1 and the second lateral surface S2, the thickness of the electrically conductive resin layer located on the first main surface M1 or the second main surface M2, or the first lateral surface S1 or the second lateral surface S2 at the middle position in the length direction is, for example, preferably about 10 μm or more and about 200 μm or less.

The plated layer includes a lower plated layer and an upper plated layer. For example, the lower plated layer is a Ni plated layer and the upper plated layer is an Sn plated layer. The plated layer may include a single layer.

The lower plated layer is provided on the electrically conductive resin layer. The lower plated layer covers at least a portion of the electrically conductive resin layer. The lower plated layer includes a first lower plated layer 23a and a second lower plated layer 23b. The first lower plated layer 23a is provided on the first electrically conductive resin layer 22a. The second lower plated layer 23b is provided on the second electrically conductive resin layer 22b.

The lower plated layer is, for example, a Ni plated layer. When using a Ni plated layer for the lower plated layer, it is possible to reduce or prevent erosion of the base electrode layer and the like by solder when mounting the multilayer ceramic capacitor 1 on a substrate.

The upper plated layer is provided on the lower plated layer. The upper plated layer covers at least a portion of the lower plated layer. The upper plated layer includes a first upper plated layer 24a and a second upper plated layer 24b. The first upper plated layer 24a is provided on the first lower plated layer 23a. The second upper plated layer 24b is provided on the second lower plated layer 23b.

The upper plated layer is, for example, an Sn plated layer. Solder spreads well on the Sn plated layer. When using a Sn plated layer for the upper plated layer, it is possible to facilitate mounting of the multilayer ceramic capacitor 1 to a substrate or the like.

The metal of the lower plated layer and the metal forming the upper plated layer are not limited to Ni or Sn. The lower plated layer or the upper plated layer can include metals such as, for example, Cu, Ni, Ag, Pd, Au or Sn, or alloys such as Ag-Pd alloy.

The thickness of the lower plated layer and the thickness of the upper plated layer are, for example, preferably about 2μm or more and about 15 μm or less.

The external electrode may include Sn, for example. Also, the content of Sn may be different between the first external electrode 20a and the second external electrode 20b.

Also, it is preferable that the shape of the first external electrode 20a and the shape of the second external electrode 20b are different. The fact that the external electrode contains Sn and that the shapes of the external electrodes are different will be explained later.

The size of the multilayer ceramic capacitor 1 is not particularly limited. A preferred length direction dimension of the multilayer ceramic capacitor 1 including the multilayer body 2 and the external electrodes is, for example, about 0.2 mm or more and about 10 mm or less. A preferred lamination direction dimension of the multilayer ceramic capacitor 1 including the multilayer body 2 and the external electrodes is, for example, about 0.1 mm or more and about 5 mm or less. A preferred width direction dimension of the multilayer ceramic capacitor 1 including the multilayer body 2 and the external electrodes is, for example, about 0.1 mm or more and about 10 mm or less.

In the multilayer ceramic capacitor 1 of the present example embodiment, for example, the first internal electrode layers 6a and the inner dielectric layers 4 are provided as a Schottky junction. On the other hand, the second internal electrode layers 6b and the inner dielectric layers 4 are provided as Schottky-junctions or ohmic contacts.

Schottky junction refers to a junction that provides rectifying action between a metal and a semiconductor. Also, rectifying action refers to the action of allowing current to flow in only one direction. Ohmic contact refers to an electrical junction in which current and voltage have a relationship according to Ohm's law.

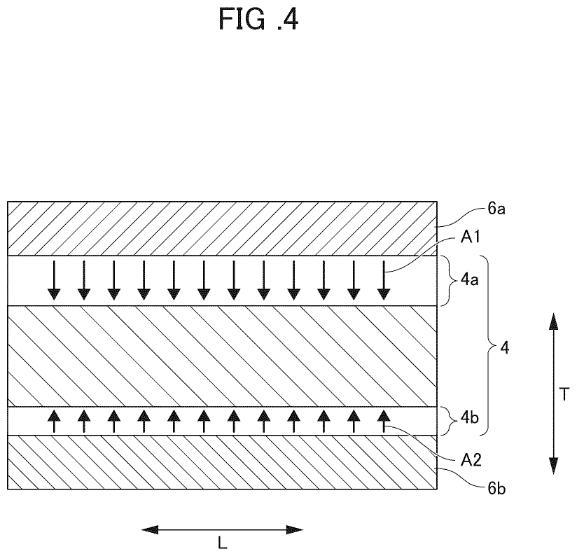

FIG. 4 is an enlarged view of the dashed line box R1 in FIG. 2. FIG. 4 shows the first internal electrode layer 6a, the second internal electrode layer 6b, and the inner dielectric layer 4 sandwiched between the first internal electrode layer 6a and the second internal electrode layer 6b.

In the multilayer ceramic capacitor 1 of the present example embodiment, the difference between the work function of the first internal electrode layer 6a and the work function of the inner dielectric layer 4 is greater than the difference between the work function of the second internal electrode layer 6b and the work function of the inner dielectric layer 4. Therefore, in a state where no voltage is applied between the first external electrode 20a and the second external electrode 20b, the electric field generated adjacent to the first internal electrode layer 6a is greater than the electric field generated adjacent to the second internal electrode layer 6b.

Arrows A1 and A2 in FIG. 4 indicate electric fields. The directions of the arrows indicate the directions of the electric fields. The lengths of the arrows indicate the strengths of the electric fields. In a state where no voltage is applied, an electric field indicated by arrow A1 is generated from the first internal electrode layer 6a toward the second internal electrode layer 6b. Also, an electric field indicated by arrow A2 is generated from the second internal electrode layer 6b toward the first internal electrode layer 6a. The electric field indicated by arrow A1 is referred to as the first electric field A1. Also, the electric field indicated by arrow A2 is referred to as the second electric field A2.

The first electric field A1 and the second electric field A2 have opposite directions. Also, the strength of the first electric field A1 is greater than the strength of the second electric field.

As shown in FIG. 4, in the multilayer ceramic capacitor 1, a residual electric field exists even in a state where no potential difference exists between the first internal electrode layer 6a and the second internal electrode layer 6b. The residual electric field is an electric field that remains after subtracting an electric field with weak electric field strength from an electric field with strong electric field strength. In the example embodiment shown in FIG. 4, the residual electric field is an electric field obtained by subtracting the second electric field A2 from the first electric field A1.

When the second internal electrode layers 6b and the inner dielectric layers 4 are in ohmic contact, the second electric field A2 becomes 0 or approximately 0. When the second electric field A2 is 0 or approximately 0, the residual electric field becomes the first electric field A1.

The multilayer ceramic capacitor 1 is mounted on a substrate such that the DC potential of the second internal electrode layer 6b becomes a high potential and the DC potential of the first internal electrode layer 6a becomes a low potential.

Here, the following junctions 1) or 2) are defined as unbalanced Schottky junctions.
1) A junction where there are two electric fields generated by Schottky junction with opposing directions and different strengths.
2) A junction where there is an electric field generated by Schottky junction and there is no other electric field to cancel it.

In the example embodiment shown in FIG. 4, the strength of the electric field generated adjacent to the first internal electrode layer 6a and the strength of the electric field generated adjacent to the second internal electrode layer 6b are different. Therefore, the junction shown in FIG. 4 is an unbalanced Schottky junction. When an unbalanced Schottky junction occurs, a residual electric field is generated there.

As an example of a method for achieving an unbalanced Schottky junction, there is a method of adjusting the work function values of each portion. The strength of the electric field generated by a Schottky junction is determined by the difference in work functions of the materials being joined. In the example embodiment shown in FIG. 4, the difference between the work function of the first internal electrode layer 6a and the work function of the inner dielectric layer 4 is different from the difference between the work function of the second internal electrode layer 6b and the work function of the inner dielectric layer 4. Therefore, the strength of the electric field generated at the junction between the first internal electrode layer 6a and the inner dielectric layer 4 is different from the strength of the electric field generated at the junction between the second internal electrode layer 6b and the inner dielectric layer 4. As a result, an unbalanced Schottky junction is provided.

Various methods can be considered to make the difference between the work function of the first internal electrode layer 6a and the work function of the inner dielectric layer 4 different from the difference between the work function of the second internal electrode layer 6b and the work function of the inner dielectric layer 4. Making the material of the first internal electrode layer 6a different from the material of the second internal electrode layer 6b is one example of such methods. When the material of the first internal electrode layer 6a and the material of the second internal electrode layer 6b are different, the junction state between the first internal electrode layer 6a and the inner dielectric layer 4 becomes different from the junction state between the second internal electrode layer 6b and the inner dielectric layer 4. As a result, it is possible to make the strength of the first electric field A1 different from the strength of the second electric field A2.

Various examples of methods can be considered for making the material of the first internal electrode layer 6a different from the material of the second internal electrode layer 6b. An example of the method will be described. The main component of the first internal electrode layer 6a and the main component of the second internal electrode layer 6b are Ni, for example. Then, for example, Sn is included in the first internal electrode layer 6a and the second internal electrode layer 6b. When including Sn, the Sn content of the first internal electrode layer 6a and the Sn content of the second internal electrode layer 6b are different from one another. By making the Sn content different, it is possible to make the material of the first internal electrode layer 6a different from the material of the second internal electrode layer 6b.

As another example of a method for providing an unbalanced Schottky junction, there is a method of making the materials of the external electrodes different. The first internal electrode layers 6a and the second internal electrode layers 6b are connected to different external electrodes. The first internal electrode layers 6a are each connected to the first external electrode 20a. The second internal electrode layers 6b are each connected to the second external electrode 20b. Therefore, by making the material of the first external electrode 20a different from the material of the second external electrode 20b, it is possible to make the junction state of the first internal electrode layer 6a different from the junction state of the second internal electrode layer 6b. This makes it possible to provide an unbalanced Schottky junction.

Various methods can be considered for making the material of the first external electrode 20a different from the material of the second external electrode 20b. As an example of the method, Sn is included in at least one of the first external electrode 20a and the second external electrode 20b. When including Sn, the Sn content of the first external electrode 20a and the Sn content of the second external electrode 20b are made different. Sn may be included in only one of them. By making the Sn content different, it is possible to make the material of the first external electrode 20a different from the material of the second external electrode 20b.

Specifically, the Sn content can be made different between the first base electrode layer 21a and the second base electrode layer 21b. Alternatively, the Sn content can be made different between the first electrically conductive resin layer 22a and the second electrically conductive resin layer 22b.

As another example of a method for providing an unbalanced Schottky junction, there is a method of making the materials of the inner dielectric layers 4 different. This is a method of making the material of the inner dielectric layer 4 in contact with the first internal electrode layer 6a different from the material of the inner dielectric layer 4 in contact with the second internal electrode layer 6b.

As shown in FIG. 4, the inner dielectric layer 4 includes a plurality of dielectric regions. Each dielectric region is made of a different material. In the example shown in FIG. 4, the inner dielectric layer 4 includes a first dielectric region 4a and a second dielectric region 4b. The first dielectric region 4a is in contact with the first internal electrode layer 6a. The second dielectric region 4b is in contact with the second internal electrode layer 6b. By forming the first dielectric region 4a and the second dielectric region 4b with different materials, an unbalanced Schottky junction can be provided.

Methods for forming the dielectric regions with different materials include, for example, making the main dielectric materials different, making the types of additives such as rare earth elements different, and making the addition amounts of additives different.

As described above, the multilayer ceramic capacitor 1 is mounted on a substrate such that the DC potential of the second internal electrode layer 6b becomes a high potential and the DC potential of the first internal electrode layer 6a becomes a low potential. When mounting the multilayer ceramic capacitor 1 on a substrate, if the first main surface M1 and the second main surface M2 can be easily distinguished, it becomes easy to accurately mount the multilayer ceramic capacitor 1 on the substrate. In other words, determining the polarity of the external electrodes is extremely important in the multilayer ceramic capacitor 1 of the present example embodiment.

Various methods can be considered for making it possible to easily distinguish between the first main surface M1 and the second main surface M2 of the multilayer ceramic capacitor 1. As an example of the method, there is a method of making the appearance of the first external electrode 20a different from the appearance of the second external electrode 20b. As a method of making the appearances different, there is a method of making the shapes of the external electrodes different. Examples of different shapes include including a notch in only one of the external electrodes and including a protrusion in only one of the external electrodes.

As another method of making the appearances different, there is an example of a method of making the colors different. Also, as another example of a method of making the appearances different, there is a method of putting a mark such as an alignment mark on only one of them.

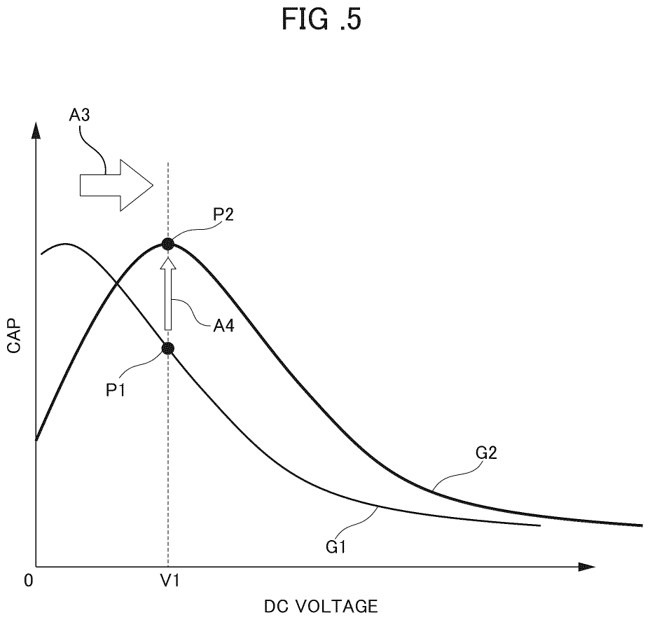

The multilayer ceramic capacitor 1 of the present example embodiment includes an unbalanced Schottky junction, such that it is possible to reduce or prevent a decrease in capacitance in a state where a DC voltage is applied. FIG. 5 is a graph showing a relationship between DC voltage and capacitance. The horizontal axis of the graph shown in FIG. 5 indicates the DC voltage applied to the multilayer ceramic capacitor 1. The vertical axis of the graph shown in FIG. 5 indicates the capacitance of the multilayer ceramic capacitor 1. Further, graph G1 shows a c-v curve of a multilayer ceramic capacitor that does not include an unbalanced Schottky junction. Graph G2 shows a c-v curve of the multilayer ceramic capacitor 1 of the present example embodiment, which includes an unbalanced Schottky junction. As shown in FIG. 5, by including an unbalanced Schottky junction, the c-v curve shifts in the positive direction of the horizontal axis. By the c-v curve shifting in the positive direction of the horizontal axis, the value of the DC voltage at which the capacitance peaks increases.

When the voltage applied to the multilayer ceramic capacitor 1 of the present example embodiment is increased, in other words, when the potential difference between the first external electrode 20a and the second external electrode 20b is increased, the residual electric field is gradually canceled. The portion indicated by arrow A3 in graph G2 of FIG. 5 corresponds to the portion where the residual electric field is being canceled. In a state where the residual electric field is completely canceled, that is, in a state where the residual electric field has disappeared, the multilayer ceramic capacitor 1 is in a state where no electric field exists despite the DC voltage being applied. That is, in the multilayer ceramic capacitor 1 of the present example embodiment, the capacitance is larger in a state where a DC voltage is applied than in a state where no DC voltage is applied. Therefore, in the multilayer ceramic capacitor 1 of the present example embodiment, it is possible to reduce or prevent a decrease in capacitance in a state where a DC voltage is applied. In other words, even when a DC voltage is applied, the multilayer ceramic capacitor 1 can maintain a high capacitance.

Hereinafter, Schottky junction will be described in more detail. Schottky junction occurs when the following conditions are satisfied.

(1) When the ceramic material of the dielectric layer is a P-type semiconductor, the ceramic material (P-type semiconductor) and the internal electrode layer (metal) define a Schottky junction when the following condition is satisfied:
<Condition> Work function φs of the ceramic material>Work function φm of the internal electrode layer.

(2) When the ceramic material of the dielectric layer is an N-type semiconductor, the ceramic material (N-type semiconductor) and the internal electrode layer (metal) define a Schottky junction when the following condition is satisfied:
<Condition> Work function φs of the ceramic material<Work function φm of the internal electrode layer.

Oxygen vacancies occur in ceramic materials including barium titanate. Oxygen vacancies define and function as donors that emit electrons. Therefore, ceramic materials including barium titanate have the properties of N-type semiconductors.

Here, the amount of oxygen vacancies changes by adding rare earth elements, for example, Dy, Ho, or the like. This indicates that the work function of the ceramic material can be adjusted to some extent by adding rare earth elements.

Rare earth elements as acceptor elements are added to the ceramic material to reduce or prevent the occurrence of oxygen vacancies. At that time, the rare earth elements are added in an amount greater than the minimum amount capable of reducing or preventing the occurrence of oxygen vacancies. As a result, the ceramic material often defines and functions as a P-type semiconductor.

Thus, the ceramic material may define and function as a P-type semiconductor or as an N-type semiconductor depending on the amount of rare earth elements added.

A case where barium titanate BaTiO₃ is used as the ceramic material of the dielectric layer will be described. Here, the barium titanate is assumed to define and function as a P-type semiconductor. The work function of barium titanate is, for example, about 4.8 eV. In order to generate a Schottky junction, the work function of the internal electrode layer needs to be less than about 4.8 eV, for example. Ni is often used as the material of the internal electrode layer. The work function of Ni is about 5.2 eV. Therefore, when the dielectric layer is made of barium titanate and the internal electrode layer is made of Ni, no Schottky junction occurs between the dielectric layer and the internal electrode layer.

Here, the work function of Sn is, for example, about 4.4 eV. Therefore, if the metal in contact with barium titanate is Sn, a Schottky junction occurs. Therefore, for example, the material of the internal electrode layer is made of Ni coated with Sn. By using Sn as a coating agent, a Schottky junction can be generated between the dielectric layer and the internal electrode layer.

When the ceramic material of the dielectric layer is barium titanate, the following example configuration can be considered as a configuration for generating an unbalanced Schottky junction. The first internal electrode layer 6a is made of Ni coated with Sn. On the other hand, the second internal electrode layer 6b is made of Ni not coated with Sn. With such a configuration, a Schottky junction occurs between the first internal electrode layer 6a and the dielectric layer. On the other hand, no Schottky junction occurs between the second internal electrode layer 6b and the dielectric layer. This makes it possible to generate an unbalanced Schottky junction.

As described above, no Schottky junction occurs between the internal electrode layer made of Ni and the dielectric layer made of barium titanate that defines and functions as a P-type semiconductor. This is because the work function of Ni (about 5.2 eV) is greater than the work function of barium titanate (about 4.8 eV).

Therefore, a semiconductor material having a work function greater than the work function of Ni is provided between the internal electrode layer made of Ni and the dielectric layer made of barium titanate. This makes it possible to generate a Schottky junction. Examples of semiconductor materials having a work function greater than the work function of Ni include the following materials: MoS₂ (work function of about 5.38 eV), MoOₓ (work function value of about 6.8 eV or less), WSe₂ (work function value of about 5.27 eV or less), CdTe (work function value of about 5.65 eV or less), CdS (work function value of about 5.87 eV or less), and the like.

An example where the ceramic material of the dielectric layer is an N-type semiconductor will be described. As described above, by reducing the amount of rare earth elements added, barium titanate can define and function as an N-type semiconductor. When barium titanate defines and functions as an N-type semiconductor, a Schottky junction can be generated between the internal electrode layer made of Ni and the dielectric layer made of barium titanate. This is because the work function φs of the ceramic material (barium titanate (about 4.8 eV))<the work function φm of the internal electrode layer (work function of Ni (about 5.2 eV)).

An example of a method for confirming that an unbalanced Schottky junction has occurred will be described. When a Schottky junction occurs, an electric field is generated in a state where no DC voltage is applied. That is, a depletion layer is generated. However, it is not easy to directly confirm the electric field or depletion layer generated by the Schottky junction.

However, it is possible to confirm whether or not an unbalanced Schottky junction has occurred by an indirect method. As Method 1, there is a method of confirming whether or not an unbalanced Schottky junction has occurred based on whether or not the capacitance increases when a DC voltage is applied. This is because an increase in capacitance when a DC voltage is applied is a phenomenon specific to the case where an unbalanced Schottky junction has occurred.

As Method 2, there is a method of confirming the work function of the material of the internal electrode layer and the work function of the dielectric material in contact with the internal electrode layer. This is because, as described above, it is possible to determine whether or not a Schottky junction has occurred based on the magnitude relationship of the work functions.

An example of a manufacturing method of the multilayer ceramic capacitor 1 according to an example embodiment will be described.

(1) Prepare a dielectric sheet and an electrically conductive paste for manufacturing internal electrode layers. The dielectric sheet and the electrically conductive paste for manufacturing internal electrode layers include a binder and a solvent. The binder may be an organic binder. The solvent may be an organic solvent.

(2) Print the electrically conductive paste for manufacturing internal electrode layers on the dielectric sheet in a predetermined pattern. An internal electrode layer pattern is formed by printing the electrically conductive paste. The printing is performed by screen printing or gravure printing, for example.

When, for example, the internal electrode layer is made of Ni coated with Sn, when the electrically conductive paste is printed, for example, a paste including Ni is printed, following which a paste including Sn may be printed thereon.

When a dielectric layer made of a material other than barium titanate is provided between the internal electrode layer and the dielectric layer made of, for example, barium titanate, a material including a material other than barium titanate may be printed on the dielectric sheet before printing the electrically conductive paste on the dielectric sheet made of barium titanate.

(3) Laminate a predetermined number of dielectric sheets for manufacturing the outer layer portion. No internal electrode layer pattern is printed on the dielectric sheets for manufacturing the outer layer portion. Dielectric sheets with printed internal electrode layer patterns are laminated on the laminated dielectric sheets. A predetermined number of dielectric sheets for manufacturing the other outer layer portion are laminated thereon. A multilayer sheet is produced by these laminations.

(4) Produce a multilayer block by pressing the multilayer sheet in the lamination direction. The pressing method can be hydrostatic pressing, for example.

(5) Cut the multilayer block to a predetermined size. Multilayer chips are cut out by this cutting. During cutting, the corner portions and ridge portions of the multilayer chips may be rounded. The method for rounding can be barrel polishing, for example.

(6) Fire the multilayer chips. Multilayer bodies are produced by this firing. The preferable firing temperature is, for example, about 900° C. or more to about 1200° C. The firing temperature can be changed according to the materials of the dielectric and the internal electrode layer.

External electrodes are provided on the multilayer body.

(7) Apply electrically conductive paste defining and functioning as a base electrode to both end surfaces of the multilayer body. The electrically conductive paste includes a glass component and a metal component. The application method can be, for example, a dipping method. After application, a firing treatment is performed. The base electrode layer is formed by this firing treatment. The preferable temperature for the firing treatment is, for example, about 700° C. or more and about 900° C. or less.

(8) Form an electrically conductive resin layer on the base electrode layer. First, prepare an electrically conductive resin paste including a resin component and a metal component. Apply the electrically conductive resin paste on the base electrode layer. The application method can be a dipping method, for example. After application, heat treatment is performed. The temperature of the heat treatment is, for example, about 200° C. or more and about 550° C. or less. By this heat treatment, the resin is thermally cured. By this thermal curing, an electrically conductive electrode layer is formed. The atmosphere during the heat treatment is, for example, preferably a nitrogen gas atmosphere. The preferable oxygen concentration during the heat treatment is, for example, 100 ppm or less. When the oxygen concentration is 100 ppm or less, the resin is less likely to scatter. Also, when the oxygen concentration is 100 ppm or less, the metal component is less likely to oxidize.

(9) After forming the electrically conductive resin layer, form a Ni plated layer on the surface of the electrically conductive resin layer. This Ni plated layer defines and functions as a lower plated layer. The method for forming the Ni plated layer may be, for example, an electrolytic plating method. The preferred plating method is barrel plating, for example.

(10) Form a Sn plated layer on the Ni plated layer. The Sn plated layer defines and functions as an upper plated layer. The method for forming the Sn plated layer may be, for example, an electrolytic plating method. The preferred plating method is barrel plating, for example.

When including Sn in the external electrodes, for example, Sn may be included in the electrically conductive paste functioning as the base electrode. Further, when making the Sn content of the first external electrode 20a different from the Sn content of the second external electrode 20b, electrically conductive pastes having different Sn contents may be prepared and applied to the desired positions.

Alternatively, when including Sn in the external electrodes, for example, Sn may be included in the electrically conductive resin paste defining and functioning as the electrically conductive resin layer. Further, when making the Sn content of the first external electrode 20a different from the Sn content of the second external electrode 20b, electrically conductive resin pastes having different Sn contents may be prepared and applied to the desired positions.

Further, when making the shape of the first external electrode 20a different from the shape of the second external electrode 20b, appropriate layers can be processed in the course of forming the external electrodes. Alternatively, after the external electrodes are formed, the shape of the first external electrode 20a and the shape of the second external electrode 20b may be made different by, for example, forming a notch in a portion of the external electrodes or pressing a mold onto the external electrodes.

While example embodiments of the present invention have been described above, the present invention is not limited to the above-described example embodiments, and variations changes, combinations, or modifications are possible and within the scope and spirit of the present invention. The scope of the present invention, therefore, is to be determined solely by the following claims.

What is claimed is:

1. A multilayer ceramic capacitor comprising:
a multilayer body including a dielectric layer, a first internal electrode layer, and a second internal electrode layer, a first main surface and a second main surface opposed to each other in a lamination direction, a first end surface and a second end surface opposed to each other in a length direction orthogonal or substantially orthogonal to the lamination direction, and a first lateral surface and a second lateral surface opposed to each other in a width direction orthogonal or substantially orthogonal to the lamination direction and the length direction;
a first external electrode connected to the first internal electrode; and
a second external electrode connected to the second internal electrode; wherein
a material of the first internal electrode layer and a material of the second internal electrode layer are different from each other;
the first internal electrode layer and the dielectric layer define a Schottky junction;
the second internal electrode layer and the dielectric layer define a Schottky junction or an ohmic contact; and
in a state where no voltage is applied between the first external electrode and the second external electrode, a difference between a work function of the first internal electrode layer and a work function of the dielectric layer is greater than a difference between a work function of the second internal electrode layer and the work function of the dielectric layer.

2. The multilayer ceramic capacitor according to claim 1, wherein the first internal electrode layer includes Ni and Sn covering the Ni.

3. The multilayer ceramic capacitor according to claim 1, wherein the first external electrode includes Sn.

4. The multilayer ceramic capacitor according to claim 1, wherein
the dielectric layer includes a plurality of different dielectric regions; and
dielectric regions of the plurality of dielectric regions in contact with the first internal electrode layer are different from dielectric regions of the plurality of dielectric regions in contact with the second internal electrode layer.

5. The multilayer ceramic capacitor according to claim 1, wherein an appearance of the first external electrode and an appearance of the second external electrode are different from each other.

6. The multilayer ceramic capacitor according to claim 1, wherein the second internal electrode layer includes Ni not covered with Sn.

7. The multilayer ceramic capacitor according to claim 1, wherein a material of the first external electrode layer is different from a material of the second external electrode layer.

8. The multilayer ceramic capacitor according to claim 1, wherein each of the first and second external electrodes includes Sn; and
an Sn content of the first external electrode is different from an Sn content of the second external electrode.

9. A multilayer ceramic capacitor comprising:
a multilayer body including a dielectric layer, a first internal electrode layer, and a second internal electrode layer, a first main surface and a second main surface opposed to each other in a lamination direction, a first end surface and a second end surface opposed to each other in a length direction orthogonal or substantially orthogonal to the lamination direction, and a first lateral surface and a second lateral surface opposed to each other in a width direction orthogonal or substantially orthogonal to the lamination direction and the length direction;
a first external electrode connected to the first internal electrode; and
a second external electrode connected to the second internal electrode; wherein
the first internal electrode layer includes Ni and Sn covering the Ni; and
the second internal electrode layer includes Ni not covered with Sn.

10. A multilayer ceramic capacitor comprising:
a multilayer body including a dielectric layer, a first internal electrode layer, and a second internal electrode layer, a first main surface and a second main surface opposed to each other in a lamination direction, a first end surface and a second end surface opposed to each other in a length direction orthogonal or substantially orthogonal to the lamination direction, and a first lateral surface and a second lateral surface opposed to each other in a width direction orthogonal or substantially orthogonal to the lamination direction and the length direction;
a first external electrode connected to the first internal electrode; and
a second external electrode connected to the second internal electrode; wherein
each of the first and second external electrodes includes Sn; and
an Sn content of the first external electrode is different from an Sn content of the second external electrode.

11. The multilayer ceramic capacitor according to claim 9, wherein the first external electrode includes Sn.

12. The multilayer ceramic capacitor according to claim 9, wherein an appearance of the first external electrode and an appearance of the second external electrode are different from each other.

13. The multilayer ceramic capacitor according to claim 9, wherein a material of the first external electrode layer is different from a material of the second external electrode layer.

14. The multilayer ceramic capacitor according to claim 9, wherein
each of the first and second external electrodes includes Sn; and
an Sn content of the first external electrode is different from an Sn content of the second external electrode.

15. The multilayer ceramic capacitor according to claim 10, wherein the first internal electrode layer includes Ni and Sn covering the Ni.

16. The multilayer ceramic capacitor according to claim 10, wherein the second internal electrode layer includes Ni not covered with Sn.

17. The multilayer ceramic capacitor according to claim 10, wherein
each of the first and second external electrodes includes a base electrode layer and a plated layer; and
the base electrode layer includes at least one of a fired layer, an electrically conductive resin layer, or a thin film layer.

18. The multilayer ceramic capacitor according to claim 9, wherein
each of the first and second external electrodes includes a base electrode layer and a plated layer; and
the base electrode layer includes at least one of a fired layer, an electrically conductive resin layer, or a thin film layer.

19. The multilayer ceramic capacitor according to claim 1, wherein
each of the first and second external electrodes includes a base electrode layer and a plated layer; and
the base electrode layer includes at least one of a fired layer, an electrically conductive resin layer, or a thin film layer.
